(19) United States
(12) Patent Application Publication
(10) Pub. No.: US 2010/0174661 A1
(43) Pub. Date: Jul. 8, 2010

(54) Wireless Branding

(75) Inventors: Kenneth Kaskoun, La Jolla, CA (US); Barry Matsumori, La Jolla, CA (US); Nicholas Yu, San Diego, CA (US); Matthew Nowak, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/629,383

(22) Filed: Dec. 2, 2009

Related U.S. Application Data
(60) Provisional application No. 61/119,056, filed on Dec. 2, 2008.

(51) Int. Cl. H04B 7/00; G06Q 99/00

(52) U.S. Cl. 705/318; 455/41.2

(57) ABSTRACT

A device wirelessly broadcasts branding information associated with a consumer product attached to the device. The branding information is sent to a receiver located remotely from the product.

### CROSS-REFERENCE TO RELATED APPLICATION

This application claims the benefit of U.S. Provisional Patent Application No. 61/119,056 filed on Dec. 2, 2008 in the names of Kaskoun et al entitled “Wireless Branding.”

### TECHNICAL FIELD

This application relates in general to electronic branding, and more specifically to a device located on a consumer product that sends information regarding the product and/or the product user to a remote receiver.

### BACKGROUND

Branding plays an important part in many companies' business. The power of a brand can be worth billions of dollars in sales. Currently branding is in many forms including TV commercials, magazine advertisements, and labels on the actual products themselves. Most of the forms are visual, and involve a stylized logo used by source companies and manufacturers to indicate a source for a particular good or service.

One issue facing source companies and manufacturers is counterfeiting. A counterfeiter will produce a good that is similar to the good marketed by the legal brand owner, and then mark the counterfeit good with the brand of the legal brand owner. Currently millions of dollars are spent on preventing the distribution of counterfeit goods.

### SUMMARY

The present disclosure is directed to systems and methods that involve a device that broadcasts information associated with a consumer product, to which the device is attached, to a receiver.

One embodiment is a system for wirelessly transmitting information. The system includes a transmitter located on one consumer product of a group of consumer products. The transmitter includes a memory that stores brand information about the consumer products. The transmitter wirelessly sends the information to a receiver, which is located remote from the consumer product. The receive is operated by a potential consumer of another of the consumer products.

In another embodiment, a system for wirelessly transmitting information includes a transmitter located on a consumer product. The transmitter includes a memory that stores brand information about the consumer product. The transmitter wirelessly sends the information to a receiver located remote from the consumer product. The receiver selectively receives the information, which includes multiple portions. The transmitter continuously transmits a first portion of information for a period of time, and the transmitter transmits a second portion of information after receiving a query from the receiver.

In yet another embodiment, a system for wirelessly transmitting information includes a receiver located remote from a consumer product. The receiver selectively wirelessly receives information from a transmitter located on the consumer product. The transmitter includes a memory that stores brand information about the consumer product, the information including multiple portions. A first portion of information is received in response to a first query from the receiver, and a second portion of information is received after a second query from the receiver.

In a further embodiment, a method for wirelessly transmitting information includes storing, in a memory, brand information about a consumer product. The memory is located in the consumer product. The method also includes transmitting the brand information from the consumer product; and receiving, by a receiver located remote from the consumer product, the brand information. The method further includes sending, by the receiver, a request for further information from the consumer product; and transmitting the further information from the consumer product after receiving the request.

In still another embodiment, a system for wirelessly transmitting information includes means for wirelessly sending information to a remote receiver. The transmitter means is located on one consumer product of a group of consumer products, and includes a memory that stores information about the consumer products. The information includes brand information about the consumer products. The receiver is operated by a potential consumer of another of the group of consumer products.

In another embodiment, a computer program product has a computer readable medium having computer program logic recorded thereon for transmitting information. The computer readable medium includes code for causing a computer to store the information, including brand information about a consumer product. The medium also includes code for causing a computer to transmit the information to a receiver located remote from the consumer product. The medium also includes code for causing the computer to receive a request for further information from the receiver.

The foregoing has outlined rather broadly the features and technical advantages of the present invention in order that the detailed description that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings.

FIG. 1 is a block diagram showing an exemplary wireless communication system in which an embodiment of the invention may be advantageously employed.

FIG. 2 depicts a block diagram showing an exemplary arrangement of a wireless device circuit.

FIG. 3 depicts a cross-section of an exemplary circuit structure of the wireless device of FIG. 2.

FIG. 4 depicts a perspective view of a button that includes the wireless device of FIG. 3.

FIGS. 5A-5C respectively depict a perspective view, a side elevation view, and a bottom elevation view of another button that includes the wireless device of FIG. 3.

FIG. 6 depicts a cross-section of an exemplary circuit of the wireless circuit in the button of FIGS. 5A-5C.

### DETAILED DESCRIPTION

Current branding techniques have several deficiencies. For example, most branding relies solely on visual cues, e.g. a mark or logo that is placed on the product. The visual cues are generally too small and are located in a position such that the cues have limited viewing angles. For example, the brand of a car is typically placed on the hood or the trunk, and is also small in comparison with the size of the car. Thus, an interested consumer would have to be located close to the car and in a position to see the front or rear of the car in order to determine the make and model of the car. This difficulty is further complicated if the car is moving. This can make the attempt to get close to the car dangerous. Brands located on smaller consumer products, e.g. garments, have similar problems. For example, on golf shirts, the brand is small, less than 1 square inch in size, and is located on one sleeve or on the chest. An interested consumer may find it difficult or uncomfortable to get close enough to discern the brand of the consumer product, or to discuss the product with a stranger.

Embodiments of the invention are directed to electronic branding, where products have a wireless device that broadcasts information associated with the product to a receiver. The information may be information about the product itself, for example the manufacturer of the product; the seller of the product; the owner of the product; the user of the product; or the owner of the brand associated with the product. The information may be about the use of the product, for example, how, when, and/or where the product is used, a status of the product, a length of use of the product, a performance metric of the product, or an environmental metric for the product. The information may identify a source for other information, for example a website or hotlink address or pathname for information. The information may be various combinations thereof. For example, the information for a garment may be one or more of the brand name of the product, the manufacturer, the date of manufacture, the name of the store that sold the garment, the price paid for the garment, the date of purchase, the brand names of related garments, the name of the user, the name of the owner, and the date the garment has last been cleaned. In one embodiment, such information is used for advertising.

The wireless device may operate to continuously send out information, such that any receiver within range of the transmitter would receive the data. Alternatively, the wireless device may operate to send out information only after being interrogated by the receiver. For example, a consumer may see a consumer good of interest, and then send a “who are you” signal to the consumer good. The wireless device associated with the good receives the signal and responds with information that describes the good. The information may be sent in one response, or over several responses. For example, after finding out the brand name of the good, the consumer may then query the wireless unit for the store name that sold the good. Additional queries are answered with additional information.

In one embodiment, the wireless device advertises the good using machine to machine information exchange. Similarly, commercial transactions can be facilitated with such machine to machine networking For example, a good can be advertised and sold via such communications.

In another embodiment the wireless device may operate to continuously send out a portion of the information. To receive the remainder of the information, a consumer may query the wireless device. For example, a wireless device may broadcast the brand name continuously. To find out where the product was purchased, a consumer would query the wireless device. The device may also send out a teaser, e.g. “I'm on sale”. A user would then query the device to find out more details, e.g. what is on sale, where is it being sold, etc. A teaser is information associated with some aspect about the product, the manufacture, etc., but is not the information itself and may be a preview of the information.

The wireless device includes a transmitter to wirelessly send the information data to the receiver. The antenna for the transmitter may be located within the wireless device, or may be separate from the device. The antenna may also include passive elements exterior to the device. For example, the active elements may be located within the device, and the passive elements may be the components used to attach the device to the consumer good. The antenna may also be located elsewhere on the consumer good, particularly for larger goods. Note that the wireless device may receive information as well. The device may receive operational instructions and/or the information that is to be broadcast, e.g. a command to send information, information updates, software updates, a command to store information, analyze data, take measurements, reset, shut down, deactivate and combinations thereof. Note that some products, e.g. mp3 players, commonly require periodic connection to a larger system for power and/or data downloading, and the information for the device may be updated or downloaded during this time.

The wireless device may use one or more technologies to transmit the information to the receiver. For example, the wireless device may use a Bluetooth transmitter, an infrared transmitter, a wireless LAN-type transmitter, a short range cellular-type transmitter, a radio frequency (RF) transmitter, a GigaHertz range transmitter, etc.

The wireless device includes memory to store the information. The memory may be one memory array to hold all of the information, or the memory may be multiple memory arrays, each holding a portion of the information. The memory may be separated into portions that are writeable by different entities. For example, one portion of memory may be writeable only by the manufacturer or brand owner. Another portion of memory may be writeable only by the seller, while another portion may be writeable only by an owner or user of the product. This would allow the different parties involved with the product to have control over aspects of the information that relate to their interest. For example, the manufacturer or brand owner could store information that identifies the product, the authenticity of the product, the brand name of the product, the name of the brand holder, etc. The seller could store information that identifies the seller, the store location that sold the product, the price of the product, etc. The user could store information that identifies the user, personal information about the user (e.g., address, phone number, e-mail address, etc.) or other such information. Each of the different areas may not be accessible by the other parties, for example a user could not change the information defining the brand name.

The information sent out by the wireless device may be controlled by the user or owner. For example, the user may elect to send out information about the brand name, but not about the seller. The user may not be able to change the information, but can control the dissemination of the information. The user may select different levels of access to the information. For example, a person that is a stranger with respect to the user may only be allowed to view minimal information, e.g., the brand name of the product. A friend of the user may be able to access more information, e.g., the store where the product was purchased and the price paid for the product. A family member may be access even more information, e.g. information describing how the product is being used. The user may be able to access all of the information, e.g., status of the product. A government enforcement agency or the brand owner may also be able to access all of the information. Thus, personal identification information may be used to return the product if it was lost or stolen. Authentication information may be used to determine if the product is genuine or counterfeit. The device may be set to default settings, such that only information about the manufacturer, brand owner, and/or seller is transmitted.

The wireless device may be located on a portion of the product such that the device does not interfere with the operation of the product. Alternatively, the device may serve a function for the device. For example, the device may be a button on a garment. The button device may function to hold portions of the garment together. Embodiments of the wireless device may optionally be hermetically sealed. Such sealing is useful if the associated product is exposed to the elements during its operation or if the product is to be cleaned. For example, if the device is located on a garment, then the garment may be subjected to moisture from rain, sweat from the wearer, and/or may washed.

The wireless device requires power for its operations. If the product associated with the device is a powered product, e.g. has a power source, generates its own power, or interfaces with a power source, then the wireless device draws power from the source of the product. For example, if the product is a cellular telephone, which uses a battery for power, then the wireless device uses power from the battery. As another example, if the product is an automobile, which generates its own electricity, then the device would be connected to the electrical system of the automobile. As a further example, if the product is a television, which plugs into the power grid, then the device is connected to the power bus of the television.

If the product associated with the device is an unpowered product, for example a garment, then the device requires its own power supply. The device may use batteries that are changeable or rechargeable by the user as the power supply. The device may use long life batteries as the power supply. These batteries do not need changing and are designed to last for an expected life of the product or an expected marketing period for the product.

Also, for unpowered products, the device may generate its own power. The device may use one or more different types of power generation to provide power for its operations. For products that operate near a light source, e.g., the sun, or artificial lighting, the device may include one or more solar panels that receives light and generates power from the light. For products exposed to RF energy, the button sensor may also have an ambient RF or direct RF generator that uses radio frequency (RF) energy to generate power. For products subjected to forces during operation or other periods, the device may include a piezoelectric power generator device to generate power from the application of physical force. For example, a shoe product may use a piezoelectric power generator to generate power while the shoes are being used. A garment product may use a piezoelectric power generator to generate power while the garment is being washed and dried. For products that are subjected to a temperature differential, the device may include a thermocouple to generate power from the temperature differential. For products that undergo motion, the device may include a kinetic generator, such that as the device is moved, it generates power. Other power sources may use a chemical reaction. In one embodiment, the power source is remote from the transmitter itself. For example, if the transmitter is included within a button, the power source could be within a garment to which the button is attached. A conductive thread could connect the power source to the transmitter in this embodiment. In other embodiments, short range magnetic conduction and/or wireless power and energy scavenging techniques (e.g., momentum sensing, light power, body heat, etc.) are used.

A device may have more than one type of power supply. For example, a device may use long life batteries, and also use solar power generation to supplement and/or extend the batteries. As another example, a device may use solar power generation and a thermocouple to generate power. Excess power can be stored in power storage, e.g., a battery or capacitor, until needed. Thus, power may be generated and used, and/or generated and stored for later use.

The wireless device may include one or more optional sensors. The sensor measures a characteristic of the associated product. For example, the sensor may determine the time of use, the length of use, and/or a place of use of the product; a performance metric of the product; an environmental metric for the product; a status metric of the product; etc. The data from the sensor may be sent as information to an interested party, e.g., the manufacturer, the brand owner, the seller, the product owner, the product user, etc.

In one embodiment, the sensor(s) is remote from the transmitter itself. For example, if the transmitter is included within a button, the sensor(s) could be within a garment to which the button is attached. A conductive thread could connect the sensor(s) to the transmitter in this embodiment.

The receiver may be a handheld device that is capable of reading the broadcasted information. For example, the handheld device may be a cellular telephone, a smart phone, a handheld personal communication systems (PCS) unit, a portable data unit such as personal data assistant, a portable music player (such as an mp3 player), a portable game device, a point of sale device, a room monitor, GPS/position location device, asset tracking device, meter reading device, etc. An interested consumer that is operating the handheld receiver can receive information from one or more wireless devices. The receiver can be set to receive information automatically, or may be set to receive information at specific times. The interested consumer can also set the receiver to alert the consumer when a particular product or type of product is broadcasting.

If the receiver has position location capabilities, enhanced shopping search capabilities can be provided. For example, locations of points of sale in the vicinity can be ascertained. Search engines and map search software can facilitate the point of sale tracking

The receiver may also be a portable device, such as a laptop, or mobile Internet device, etc. The receiver may also be a nonportable device, such as a personal computer, a server, meter, a base station, a security station (e.g. a walk-through metal detector). These types of receivers are useful at transportation hubs and ports of entry, and may be used to search for counterfeit goods.

The receiver may be omnidirectional, and thus receive information from wireless devices located around the receiver. Alternatively, the receiver may be unidirectional, e.g., line of sight, such that the receiver would only receive information from a particular direction. This would allow an interested consumer to more accurately select a particular product on which to receive information. This is useful in locations where a large number of products are transmitting. For example, a shopping mall, a store, or a large gathering of people.

The receiver may also organize the received devices in a manner that allows for a large number of products to be handled by the receiver. For example, the receiver may organize the received devices by product type, by product brand name, by distance, by user selection, combinations thereof, etc. The receiver may further organize the received devices into subcategories.

The receiver may receive the information for immediate viewing, or may store the information for later use. For example, an interested consumer may be occupied with a task and unable to review the received information. The receiver would store the information for later review.

The receiver may have access to a network, e.g. the Internet, and thus be able to access a website for information when directed to the website by the wireless transmitter device. For example, if a consumer indicates he/she is interested in buying the product, the seller or brand owner can identify a nearby store that is selling the product. If the receiver is GPS equipped, then the seller or brand owner can direct the consumer to a store selling the product. In one embodiment, the store's current inventory of the product, current price, upcoming sales, and latest buyer reviews are provided to the receiver, either directly or via being directed to a web site. Such information can be received by the wireless device via updates

The receiver may track products indicated by the consumer (the receiver user), and relay the information to the brand owner and/or seller. This provides feedback to the brand owner and/or seller about the interest in a product.

As stated earlier, counterfeiting is a problem for manufacturers, brand owners, and consumers. Embodiments of the invention can be used to reduce counterfeiting. An interested consumer can scan a product to see if the product has a wireless transmitter device. The lack of the device may in and of itself indicate the product is counterfeit. Furthermore, additional aspects may be used to ensure the authenticity of the product. For example, the wireless transmitter device may include a unique serial number. The receiver can check to see if the serial number is proper. The serial number may also be associated with a particular seller. Thus the user can verify that the entity selling the product is correct, helping to ensure that counterfeit goods are not being purchased by an unwary consumer. Furthermore, at border points, distribution centers, transportation hubs, and other such locations, shipments of goods can be scanned by a government agency, a seller, etc. to determine if the goods are counterfeit.

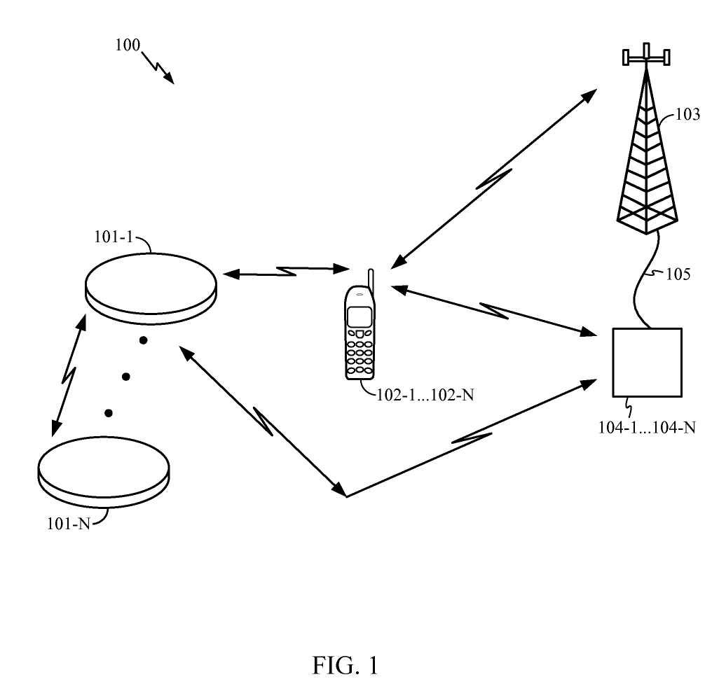

FIG. 1 is a schematic diagram of an exemplary arrangement of a wireless communication system 100 that includes at least one wireless device 101-1, 101-N that is attached to a consumer product. For purposes of illustration, FIG. 1 depicts multiple devices 101-1 to 101-N communicating with receivers 102 and 104. The receiver 102 may be a handheld receiver, such as cell phone or personal data assistant, while the receiver 104 may be fixed or portable, e.g., a base monitor, a meter reader, or laptop computer. Note that this is by way of example only, as there may only be one device 101, and there may be more/fewer receivers. The devices 101 may communicate with either receiver 102, 104. Each of the receivers may send data to or receive data from the devices. The receivers 102, 104 may communicate with each other, either directly, or by using a cell system 103, or a cell system that is coupled to a land line system 105.

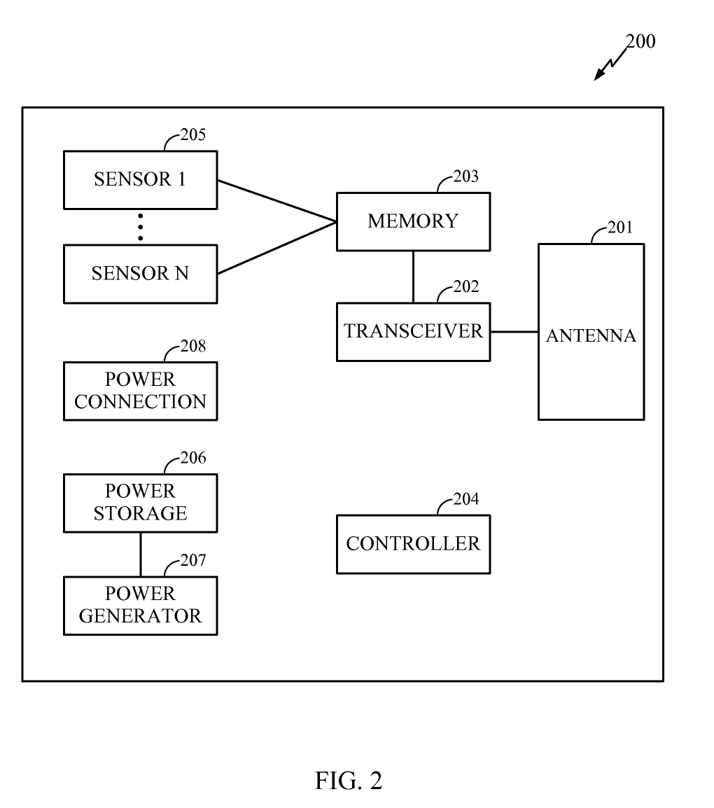

FIG. 2 depicts a block diagram showing an exemplary arrangement of a wireless device circuit 200 that is located on a consumer product according to embodiments of the invention. The circuit 200 uses a controller 204 to manage operations of the circuit 200. The controller 204 executes software stored in a memory 203 in performing its various functions. The memory 203 stores the information associated with the consumer product. The circuit 200 uses a transceiver 202 to send the information to a receiver. The controller 204 may direct the transceiver 202 as to when to send the information. Alternatively, the transceiver may be set to continuously send the information. The transceiver 202 is coupled to an antenna 201 to send the information. The transceiver 202, via the antenna 201, may also receive information from an external source. The received data may be operating commands, e.g., turn on/off, send information, etc, or may be other data, e.g., software updates, initial product information, updated product information, etc.

In one embodiment, the antenna 201 is remote from the transceiver 202 itself. For example, if the transceiver 202 is included within a button, the antenna 201 could be within a garment to which the button is attached. A conductive thread could connect the antenna 201 to the transceiver 202 in this embodiment.

The circuit 200 requires power, which may be provided by a power connection 208, which connects the circuit 200 to the power available from the product. Alternatively, the circuit 200 may be self-powered and includes at least a power storage device 206. The device 206 may be a battery, a capacitor, or other power storage unit. The battery may be recharged or replaced by a product user or owner. The circuit may also include a power generator 207 that generates power for use by the circuit 200. Excess power is stored in the power storage device 206. The controller 204 may direct the power generator 207 as to when to operate. Alternatively, the power generator 207 may be set to continuously operate, so long as capable.

The circuit 200 may optionally include at least one sensor 205 that measures a metric. The circuit may optionally include multiple sensors, each of which measures a different metric. The controller 204 may direct the sensor 205 as to when and how long to take measurements. Alternatively, the sensor may be set to continuously take measurements. The data from the measurements are stored in the memory 203 for delivery to the receiver as information.

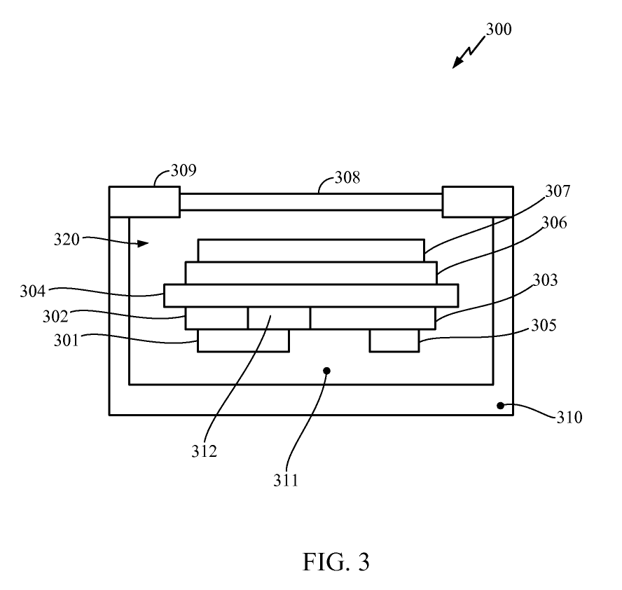

FIG. 3 depicts a cross-section of an exemplary circuit 300 of the wireless circuit 200 of FIG. 2. The circuit 300 in this arrangement is a through silicon stacked (TSS) integrated circuit (IC). The various layers would communicate with each other and be powered by vertical through silicon vias (TSVs). Note that this arrangement is by way of example only, as other types of circuits may be used.

The circuit 300 includes a substrate 304, upon which other circuit components are stacked. The various components function as described in the preceding paragraphs. The circuit includes a controller 302, and a memory 303. The circuit 300 also includes power storage 306 and a power generator 307. As an example, the circuit 300 uses a solar panel as the power generator 307. Thus, a lid 309 includes a window 308 to allow light (either visible and/or infrared light) to reach the solar panel. The circuit 300 also includes an antenna 301 and transceiver 312. The circuit 300 may also include an optional sensor 305. In this example, the circuit 300 is located in a package 310, and surrounded by a material 311, such as a plastic or epoxy, to protect the circuit 300. The connection between the lid 309 and the package 310 is hermetically sealed.

The present disclosure can also be used in inventory systems. For example, personal property can be wirelessly branded enabling a consumer to inventory his/her personal property. In one embodiment, receivers and appropriate software would thus enable machine-to-machine inventory management systems. Similarly, asset tracking systems and theft recovery systems are contemplated. Moreover, the present disclosure can enhance insurance of property items.

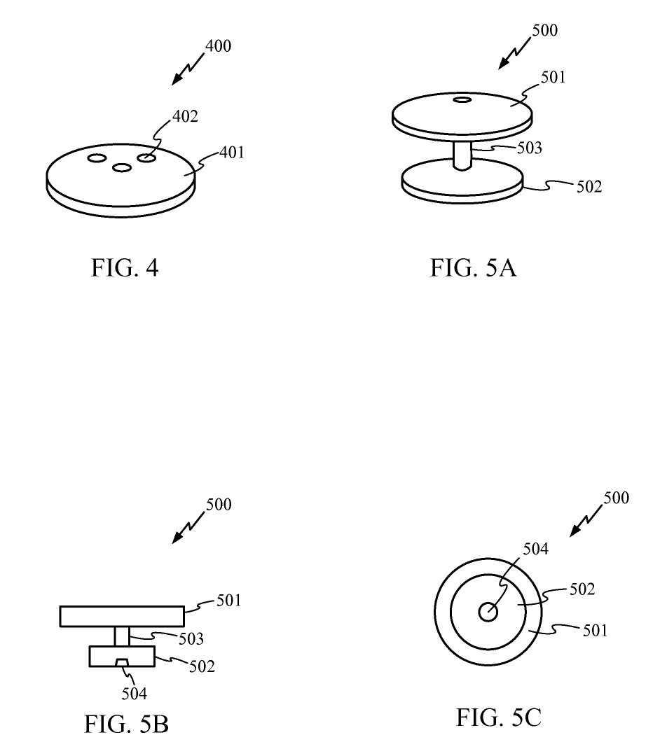

There are many possible structures for the components of the wireless branding system. For example, FIG. 4 depicts a perspective view of a button that includes the wireless device of FIG. 2. In this arrangement, the button 400 would be secured to an article of clothing or garment via the holes 402. Thread, wire, pins, rivets, etc. would pass through the holes and connect the button to the garment. The button 400 includes a sealed container 401 that includes the wireless device (not shown). In some embodiments this wireless device (not shown) may sense data for a metric from a living being wearing the garment. The wireless sensor is formed into a shape that allows the holes 402 to pass through the button 400 without interfering with the operation of the wireless sensor.

The button 400 can be formed using many different production processes. For example, the button 400 can be formed by using an injection molding process. The wireless sensor is placed into an injection mold. Material is then injected into the mold to encapsulate the wireless sensor and form the button 400. The holes 402 may then be drilled into the button or may be formed as part of the injection molding process. The button 400 can also be formed by using a package. The button is secured in a package. A lid is then welded, e.g. via ultrasonic welding, onto the package. The holes 402 already exist in the package and the lid. Either process results in a hermetically sealed button 400 that comprises the wireless sensor. Note that other processes may be used to form the button 400, as long as the button 400 is hermetically sealed and able to perform the functions described herein.

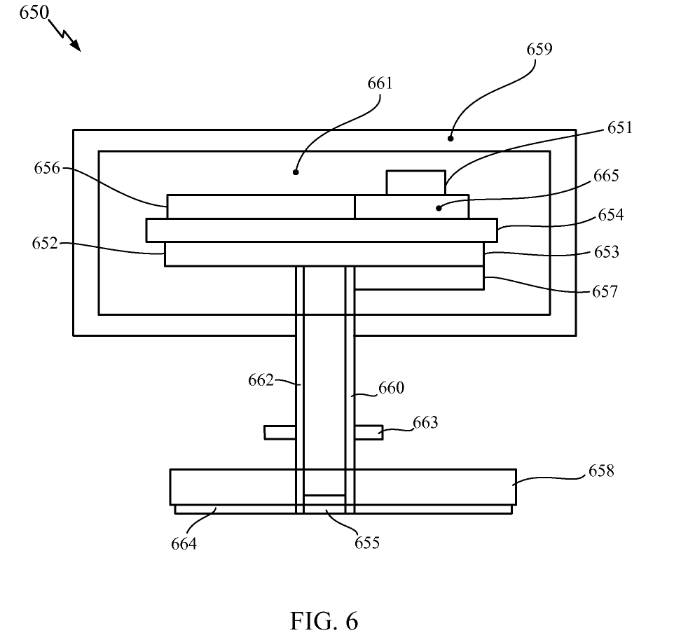

FIGS. 5A-5C respectively depict a perspective view, a side elevation view, and a bottom elevation view of another button 500 that includes the wireless device of FIG. 2. In this arrangement, the button 500 would be secured to an article of clothing or garment via an attachment assembly including a post 503 and a base 502. The button 500 has an upper portion 501 that is a sealed container and includes a wireless sensor (not shown) that may sense data for a metric from the living being wearing the garment. The button 500 is attached to a garment by passing the post 503 through the garment. The base 502 is then secured to the post by riveting the base 502 to the post 503. The base 502 may also be secured to the post 503 by an adhesive, welding (e.g. ultrasonic welding), screwing the base 502 to the post 503, friction, etc.

In this embodiment, the post 503 and the base 502 may perform functions beyond attaching the button 500 to the garment. The post 503 and the base 502 may comprise power storage and/or power generation aspects of the button 500. For example, the base 502 and/or the post 503 may include a battery, capacitor, or other power storage unit. Furthermore, the base 502 may serve as a heat sink for a thermocouple power generator. The base 502 is adjacent to or in contact with the body of the wearer of the garment, and thus is exposed to body heat. The upper portion is located away from the body, and is exposed to ambient temperature. The upper portion may then use the temperature differential to generate electricity. The post 503 would conduct the body heat from the base 502 to the upper portion 501. As another example, the base 502 may comprise an infrared solar panel to generate electricity from body heat.

The post 503 and the base 502 may also be part of the antenna of the button. For example, the base 502 may have a passive element energized by an active element located within the upper portion 501. The base 502 may also have an active element of the antenna that is connected to a signal source located within the upper portion 501 through the post 503.

The base 502 may also include a sensor 504 that is used to measure a metric of the wearer of the garment. The base 502 is adjacent to or in contact with the body of the wearer of the garment, and thus the senor 504 would be able to more accurately measure the desired metric.

The button 500 may be formed by using either the injection molding process or the packaging process described above with respect to the button 400. Note that other processes may be used to form the button 500, as long as the button 500 is hermetically sealed and able to perform the functions described herein.

FIG. 6 depicts a cross-section of an exemplary circuit 650 of the wireless circuit 300 of FIG. 3 embedded in the button sensor 500 of FIGS. 5A-5C. The circuit 650 in this arrangement is a through silicon stacked integrated circuit. The various layers would communicate with each other and be powered by vertical through silicon vias. Note that this arrangement is by way of example only, as other types of circuits may be used.

The circuit 650 includes a substrate 654, upon which other circuit components are stacked. The various components function as described in the preceding paragraphs. The circuit includes a controller 652, and a memory 653. The circuit 650 also includes a power storage 656 and a power generator 657. As an example, the circuit 650 uses a thermocouple as the power generator 657. Thus, heat from the body of the wearer is transmitted from the base 658 to the power generator 657. To facilitate heat transfer, the post 660 includes heat conductive material 662, e.g. a metal. Similarly, the base 658 also includes a heat conductive material 664. The metal may be coated with a material to prevent corrosion. The circuit 650 also includes an antenna 651 and a transceiver 665. The sensor 655 of the circuit 600 is located at the base of the post 660. This location places the sensor either directly in contact with the wearer or adjacent to the wearer. As an example, the sensor 655 detects the temperature of the wearer. In this example, the circuit is formed in a button that has been injection molded.

The button may include an outer layer 659 of a decorative material. The injection molding surrounds the circuit 650 with a material 661, such as plastic or epoxy. The package may be formed by injection molding or insert molding. A retaining clip 663 is also shown. The retaining clip 663 holds a garment between the retaining clip 663 and the base 658 to prevent the garment from riding up the post 660.

Although specific circuitry has been set forth, it will be appreciated by those skilled in the art that not all of the disclosed circuitry is required to practice the invention. For example, the controller and memory could be integrated into a single chip. Similarly, the power storage and power generator could be implemented as a single chip. Other combinations of separately shown (or combined) circuits are also contemplated. Moreover, certain well known circuits have not been described, to maintain focus on the invention.

Note that any of the functions described herein may be implemented in hardware, software, and/or firmware, and/or any combination thereof. When implemented in software, the elements of the present invention are essentially the code segments to perform the necessary tasks. The program or code segments can be stored in a processor readable medium. The “processor readable medium” may include any medium that can store or transfer information. Examples of the processor readable medium include an electronic circuit, a semiconductor memory device, a ROM, a flash memory, an erasable ROM (EROM), a floppy diskette, a compact disk CD-ROM, an optical disk, a hard disk, a fiber optic medium, etc. The code segments may be downloaded via computer networks such as the Internet, Intranet, etc.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for wirelessly transmitting information comprising:
a transmitter that is located on one consumer product of a plurality of consumer products, and includes a memory that stores information about the plurality of consumer products, wherein the information includes brand information about the consumer products, the transmitter adapted for wirelessly sending the information to a receiver located remote from the one consumer product and operated by a potential consumer of another of the plurality of consumer products.

2. The system of claim 1, wherein the receiver is one of:
a cellular telephone, a smart phone, a handheld personal communication system unit, a personal data assistant, a portable music player, a portable game device, a point of sale device, a room monitor, a laptop, a mobile Internet device, a personal computer, a server, meter, a base station, and a security station.

3. The system of claim 1, wherein the information comprises at least one of:
a name of the manufacture of the products, a name of the brand owner of the products, a name of a seller of the one product, a name of an owner of the one product, a name of a user of the one product, a website address related to the products, information about a use of the one product, a status of the one product, a time of use of the one product, the length of use of the one product, a place of use of the one product; a performance metric of the one product; and an environmental metric for the one product.

4. The system of claim 1, wherein the transmitter continuously transmits the information for a period of time.

5. The system of claim 1, wherein the transmitter transmits the information in response to a query from the receiver.

6. The system of claim 1, wherein the information comprises a plurality of portions, the transmitter continuously transmits a first portion of information for a period of time, and the transmitter transmits a second portion of information after receiving a query from the receiver.

7. The system of claim 1, wherein the information comprises a plurality of portions, the transmitter transmits a first portion information after receiving a first query from the receiver, and the transmitter transmits a second portion of information after receiving a second query from the receiver.

8. The system of claim 1, wherein the information comprises a plurality of portions, and at least one portion is owned by one entity of a plurality of entities consisting of:
a brand owner of the products, a seller of the one product, and a user of the one product;
wherein the portion owned by one entity cannot be changed by another entity.

9. The system of claim 1, wherein the information comprises a plurality of portions, and the transmitter is operative to send the portions to the receiver based on an identity of the receiver.

10. The system of claim 9, wherein a level of familiarity of a user of the receiver with respect to user of the transmitter is used to determine which portions of the information are provided to the receiver.

11. The system of claim 1, wherein a user of the transmitter controls the operation of the transmitter.

12. The system of claim 1, wherein the information is used to determine authenticity of the product.

13. The system of claim 1, wherein the transmitter comprises at least one of a power connection, a power storage device, and a power generating device.

14. The system of claim 13, wherein the power storage device is one of a battery and a capacitor.

15. The system of claim 13, wherein the power generating device is one of:
a solar panel, an infrared solar panel, a thermocouple, a kinetic generator, a piezoelectric device, a solar device, a thermocouple device, kinetic a device, an ambient RF device, a directed RF device, a piezoelectric device, and a chemical device.

16. A system for wirelessly transmitting information comprising:
a transmitter that is located on a consumer product, and includes a memory that stores information about the consumer product, the information including brand information about the consumer product, the transmitter adapted for wirelessly sending the information, which comprises a plurality of portions, the transmitter continuously transmitting a first portion of information for a period of time, the transmitter being adapted to transmit a second portion of information after receiving a query.

17. The system of claim 16, wherein the information comprises at least one of:
a name of the manufacture of the product, a name of the brand owner of the product, a name of a seller of the product, a name of an owner of the product, a name of a user of the product, a website address related to the product, information about a use of the product, a status of the product, a time of use of the product, the length of use of the product, a place of use of the product; a performance metric of the product; and an environmental metric for the product.

18. The system of claim 16, wherein the information is used to determine authenticity of the product.

19. A system for wirelessly transmitting information comprising:
a receiver, which is located remote from a consumer product, and selectively wirelessly receives information from a transmitter located on the consumer product, the transmitter including a memory that stores brand information about the consumer product, the information including a plurality of portions, a first portion of information being received in response to a first query from the receiver, and a second portion of information being received after a second query from the receiver.

20. The system of claim 19, wherein the receiver is one of:
a cellular telephone, a smart phone, a handheld personal communication system unit, a personal data assistant, a portable music player, a portable game device, a point of sale device, a room monitor, a laptop, a mobile Internet device, a personal computer, a server, meter, a base station, and a security station.

21. The system of claim 19, wherein the information comprises at least one of:
a name of the manufacture of the product, a name of the brand owner of the product, a name of a seller of the product, a name of an owner of the product, a name of a user of the product, a website address related to the product, information about a use of the product, a status of the product, a time of use of the product, the length of use of the product, a place of use of the product; a performance metric of the product; and an environmental metric for the product.

22. The system of claim 19, wherein the information is used to determine authenticity of the product.

23. The system of claim 19, wherein the receiver, after receiving the information, connects with another entity that is remote from the receiver, and provides acknowledgement of the information to the another entity.

24. A method for wirelessly transmitting information comprising:
storing in a memory, brand information about a consumer product, wherein the memory is located in the consumer product;
transmitting the brand information from the consumer product,
receiving a request for further information at the consumer product; and
transmitting the further information from the consumer product after receiving the request.

25. The method of claim 24, further comprising:
receiving the further information by a receiver that is located remote from the consumer product;
using, by the receiver, the information to access a website with other information related to the consumer product.

26. The method of claim 24, wherein the receiver is one of:
a cellular telephone, a smart phone, a handheld personal communication system unit, a personal data assistant, a portable music player, a portable game device, a point of sale device, a room monitor, a laptop, a mobile Internet device, a personal computer, a server, meter, a base station, and a security station.

27. A system for wirelessly transmitting information comprising:
means for wirelessly transmitting information to a remote receiver, the transmitter means located on one consumer product of a plurality of consumer products, and storage means that stores information about the plurality of consumer products, wherein the information includes brand information about the consumer products.

28. A computer program product having a computer readable medium having computer program logic recorded thereon for transmitting information, the computer readable medium comprising:
code for causing a computer to store the information, including brand information about a consumer product;
code for causing a computer to transmit the information to a receiver located remote from the consumer product; and
code for causing the computer to receive a request for further information from the receiver.

29. The computer program product of claim 28, wherein the further information comprises at least one of:
a name of the manufacture of the product, a name of the brand owner of the product, a name of a seller of the product, a name of an owner of the product, a name of a user of the product, a website address related to the product, information about a use of the product, a status of the product, a time of use of the product, the length of use of the product, a place of use of the product; a performance metric of the product; and an environmental metric for the product.
